(19) United States
(12) Patent Application Publication
(10) Pub. No.: US 2025/0220099 A1
(43) Pub. Date: Jul. 3, 2025

(54) CALL CONTEXT REQUEST PRIOR TO ANSWER

(71) Applicant: T-Mobile USA, Inc., Bellevue, WA (US)

(72) Inventors: Harikishore Allu Balan, Lynnwood, WA (US); Jagannadha Anudeep Varma Datla, Kent, WA (US); Saqib Badar, Bellevue, WA (US)

(21) Appl. No.: 18/399,211

(22) Filed: Dec. 28, 2023

(51) Int. Cl. H04M 1/57; G10L 15/26

(52) U.S. Cl. CPC H04M 1/578; G10L 15/26

(57) ABSTRACT

Solutions are disclosed that request call context from the caller prior to answer by the called user equipment (UE). When the called UE receives an incoming call from a remote telephone, without accepting the incoming call, the called UE requests that the wireless network anchor the incoming call. The anchor point is a media resource function (MRF), in some examples. A request for call context is transmitted to the remote telephone (an audio request, in some examples). The MRF converts the incoming reply from the remote telephone to real time text (RTT), which is sent to the called UE, over the default bearer (in some examples). With the call context thus provided, the user of the called UE may make an informed decision of whether to accept the incoming call.

### BACKGROUND

Annoying, unsolicited phone calls are so pervasive that many people do not answer phone calls when from unrecognized phone numbers. The unanswered calls are then diverted to voicemail. This creates two problems: First, a valuable incoming call may be missed, and second, the called party's voicemail may have a large number of voicemail notifications for some percentage of the unwanted incoming calls.

The current solution to the first problem, if the called party is expecting an important call during some time period, is to answer all of the incoming calls during the time period and waste time on the unwanted calls. The current solution to the second problem is for the called party to devote a non-trivial amount of time parsing through all of the voicemails from the unwanted incoming calls, listen long enough to determine whether the message is important, and then delete the unimportant ones. Both solutions waste the time of the called party.

### SUMMARY

The following summary is provided to illustrate examples disclosed herein, but is not meant to limit all examples to any particular configuration or sequence of operations.

Solutions are disclosed that request call context from the caller prior to answer by the called user equipment (UE). Examples include: receiving, by a first UE operating on a wireless network, an incoming call from a remote telephone; without accepting the incoming call, requesting, by the first UE, that the wireless network anchor the incoming call; and receiving, by the first UE, a real time text (RTT) response to an audio request for call context, the RTT response having been converted, by the wireless network, from an audio response to the RTT response.

### BRIEF DESCRIPTION OF THE DRAWINGS

The disclosed examples are described below with reference to the accompanying drawing figures listed below, wherein:

FIG. 1 illustrates an exemplary architecture that advantageously requests call context for an incoming call from the caller prior to the called user equipment (UEs) answering;

FIG. 2 illustrates another wireless network of the UE placing the incoming call for which the example architecture of FIG. 1 requests call context;

FIG. 3 illustrates further detail for the called UE in the architecture of FIG. 1;

FIG. 4 illustrates a message sequence diagram of massages that may be used in examples of the architecture of FIG. 1;

FIGS. 5 and 6 illustrate additional flowcharts of exemplary operations associated with the architecture of FIG. 1; and

FIG. 7 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that request call context from the caller prior to answer by the called user equipment (UE). When the called UE receives an incoming call from a remote telephone, without accepting the incoming call, the called UE requests that the wireless network anchor the incoming call. The anchor point is a media resource function (MRF), in some examples. A request for call context is transmitted to the remote telephone (an audio request, in some examples). The MRF converts the incoming reply from the remote telephone to real time text (RTT), which is sent to the called UE, over the default bearer (in some examples). With the call context thus provided, the user of the called UE may make an informed decision of whether to accept the incoming call.

Aspects of the disclosure improve the efficiency of cellular networks by reducing unwanted traffic—such as incoming calls that are unwanted by the called party. Some examples reduce the storage burdens on voicemail equipment by further diverting unwanted incoming calls away from voicemail. Further, this improves human-machine interaction by reducing the number of answered intrusive incoming calls, reducing the number of missed important incoming calls, and reducing the time spent by a human user wading through unwanted voicemail messages. These advantages may further combine to extend UE battery life, due to the reduced UE radio usage wasted on unwanted incoming calls and voicemail messages.

These advantageous results are accomplished, at least in part by, without accepting an incoming call, requesting, by a UE, that the wireless network anchor the incoming call, and receiving, by the UE, an RTT response to an audio request for call context, the RTT response having been converted, by the wireless network, from an audio response to the RTT response.

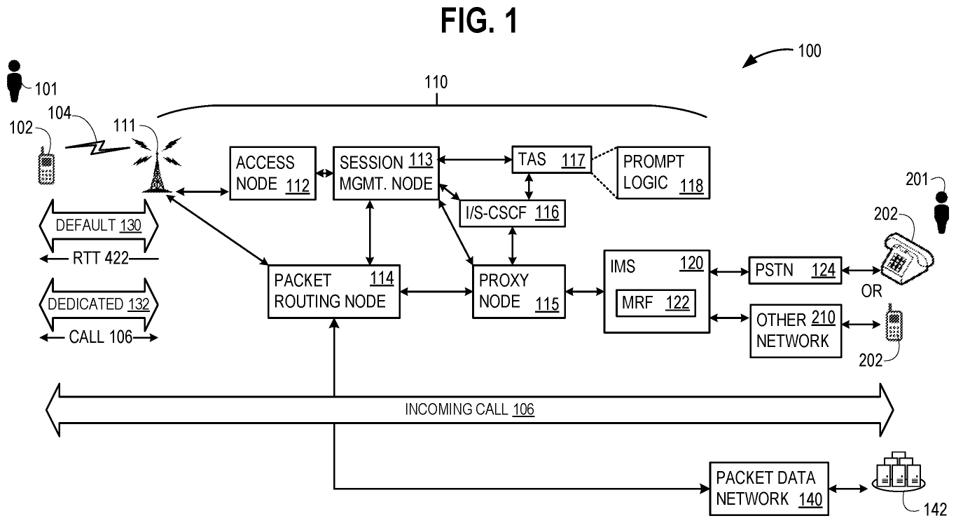

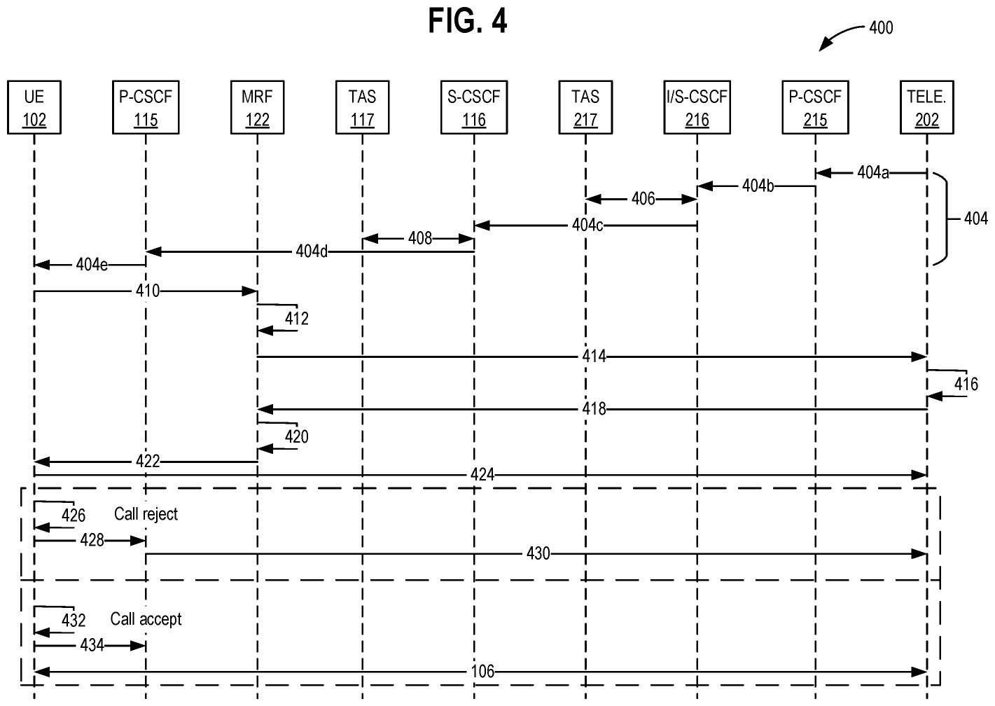

With reference now to the figures, FIG. 1 illustrates an exemplary architecture 100 that advantageously requests call context from a caller 201, prior to answer of an incoming call 106 by a called party 101 using a UE 102. UE 102 is being served by a wireless network 110, which carries signaling (shown in FIG. 4) for incoming call 106, enabling a remote telephone 202 used by caller 201 to reach UE 102. In some examples, incoming call 106 may comprise a voice call.

In some examples, remote telephone 202 comprises another cellular UE being served by a wireless network 210 (shown in FIG. 4), whereas in some other examples, remote telephone 202 comprises a landline telephone connected to a public switched telephone network (PSTN) 124 (also known as plain old telephone system, POTS). In both scenarios, wireless network 210 and PSTN 124 connect to wireless network 110 through an internet protocol (IP) multimedia subsystem (IMS) 120, which has an MRF 122.

UE 102 uses an air interface 104 to communicate with a base station 111 of wireless network 110. Wireless network 110 may be a cellular network such as a fifth generation (5G) network, a fourth generation (4G) network, or another cellular generation network. In some scenarios, base station 111 may also be referred to as a radio access network (RAN). Wireless network 110 has an access node 112, a session management node 113, a packet routing node 114, a proxy node 115, an interrogating/serving call session control function (I/S-CSCF) 116, and a telephony application server (TAS) 117. Access node 112, session management node 113, and TAS 117 are within a control plane of wireless network 110, and packet routing node 114 is within a user plane of wireless network 110.

Base station 111 is in communication with access node 112 and packet routing node 114. Access node 112 is in communication with session management node 113 which is in communication with packet routing node 114, proxy node 115, I/S-CSCF 116, and TAS 117. Packet routing node 114 is in communication with proxy node 115, and a packet data network 140. In some 5G examples, base station 111 comprises a gNodeB (gNB), access node 112 comprises an access mobility function (AMF), session management node 113 comprises a session management function (SMF), and packet routing node 114 comprises a user plane function (UPF). In some 4G examples, base station 111 comprises an eNodeB (eNB), access node 112 comprises a mobility management entity (MME), session management node 113 comprises a system architecture evolution gateway (SAEGW) control plane (SAEGW-C), and packet routing node 114 comprises an SAEGW-user plane (SAEGW-U). In some examples, proxy node 115 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, a cell site at which base station 111 is located may host both a gNB or eNB (or multiple ones of each) and cellular service a mix of 5G and 4G (or some other cellular generation). In some examples, proxy node 115 may be considered to be within IMS 120.

Proxy node 115 is in communication with IMS 120, in order to provide connectivity to other wireless (cellular) networks, such as wireless network 210, or a PSTN, such as PSTN 124), to support calls with telephones that are not being served by wireless network, such as remote telephone 202. UE 102 is able to reach a network resource 142 using packet data network 140, in some examples. Packet data network 140 may be or include the internet, and network resource 142 may be or include a website. Data packets from UE 102 (including voice data packets for voice calls) pass through at least base station 111, packet routing node 114, and proxy node 115 on their way to/from IMS 120. Signaling traffic, however, may pass through access node 112.

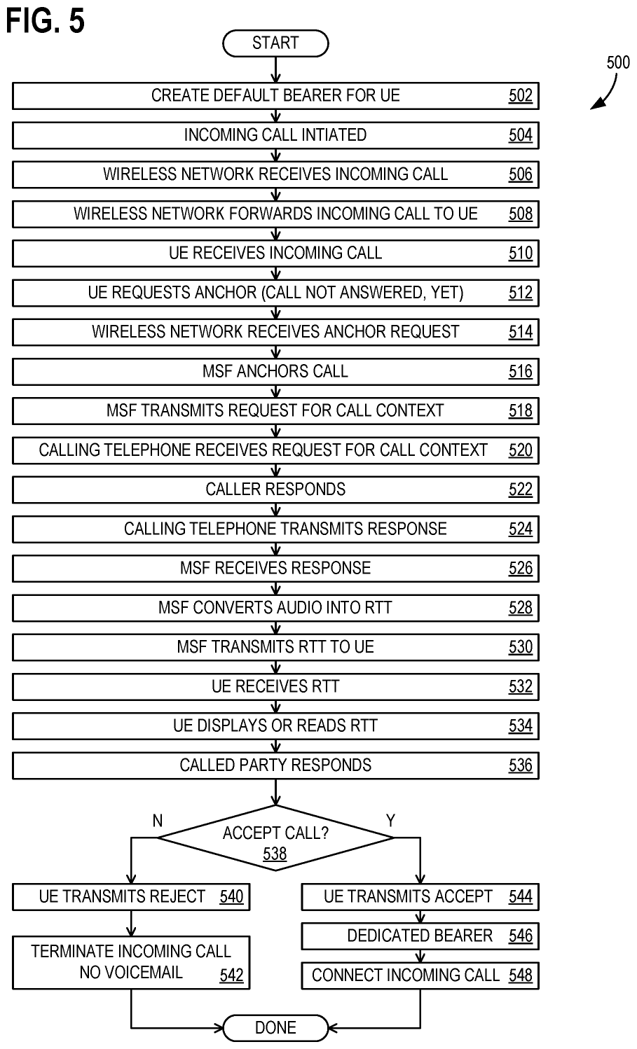

As illustrated, TAS 117 has prompt logic 118 for anchoring incoming call 106 (e.g., at MRF 122) and transmitting a request for call context to remote telephone 202. The functionality of prompt logic 118 is described below, such as to control or provide input to some of operations 516-542 of FIG. 5. Although prompt logic 118 is illustrated as being within TAS 117, various examples may have the functionality located elsewhere and/or distributed among various components of architecture 100. For example, prompt logic 118 may be partially or fully within proxy node 115 and/or I/S-CSCF 116.

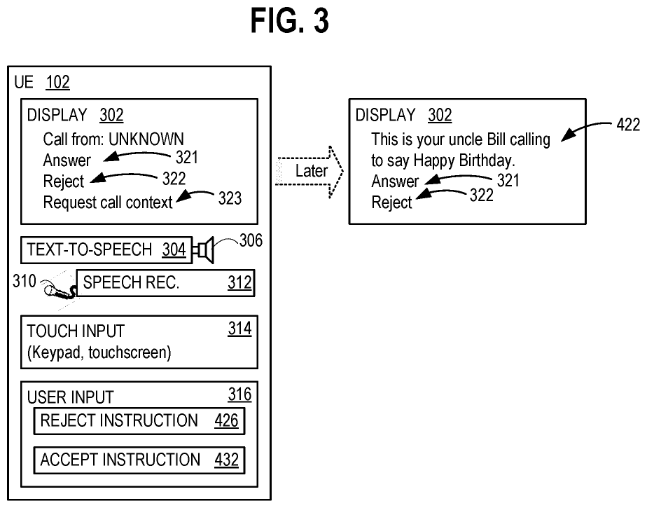

A default bearer 130 is set up for UE 102 when UE 102 registers with and connects to wireless network 110. Default bearer 130 is typically a non-guaranteed bitrate (non-GBR) channel, and is used for signaling between wireless network 110 and UE 102, such as signaling for incoming call 106. However, in architecture 100, default bearer 130 is also used to carry an RTT response 422, which is a response to the request for call context sent to remote telephone 202. An example RTT response 422 is shown in FIG. 3, and RTT response 422 is described in further detail in relations to FIGS. 4 and 5.

A dedicated bearer 132 is set up when (if) incoming call 106 is accepted by and connected to UE 102. Dedicated bearer 132 may be a guaranteed bitrate (GBR) channel, and is used for carrying delay-sensitive data packets to/from UE 102, such as voice data packets for incoming call 106. In some examples, dedicated bearer 132, or a parallel dedicated bearer is used for carrying and RTT messages between UE 102 and remote telephone 202 while incoming call 106—if remote telephone 202 has RTT capability. As used herein, RTT is not short message service (SMS) text, but instead the RTT service described in Third Generation Partnership Program (3GPP) technical specification (TS) 23.226, or an equivalent. The 3GPP RTT has service requirements and capabilities not met by SMS.

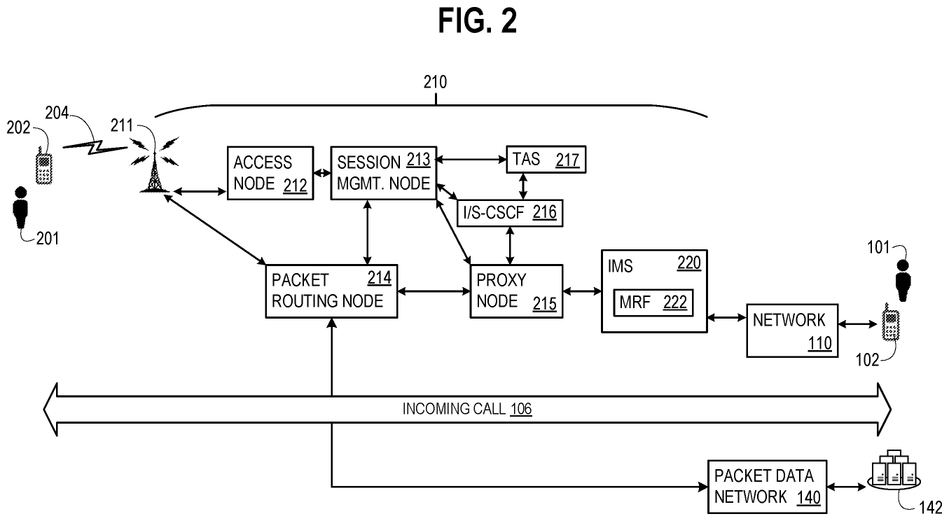

In some examples, only called UE 102 has RTT capability and remote telephone 202 does not have RTT capability (although it may have SMS capability). In such examples, even if remote telephone 202 is another cellular UE being served by wireless network 110, the audio to RTT conversion of architecture 100 is required. In some examples, UE 102 and remote telephone 202 both have RTT capability, but are on different cellular networks (i.e., remote telephone 202 is being served by wireless network 210, rather than wireless network 110). In such examples, the audio to RTT conversion of architecture 100 may still be required. This scenario is depicted in FIG. 2, which illustrates wireless network 210 used by remote telephone 202, when remote telephone 202 is a cellular UE.

The components shown for wireless network 210, in FIG. 2, are equivalent to their corresponding similarly-named counterparts depicted in FIG. 1 for wireless network 110. For example, remote telephone 202 (when it is a cellular UE) uses an air interface 204 to communicate with a base station 211 of wireless network 210. Wireless network 210 may be a cellular network such as a 5G network, a 4G network, or another cellular generation network. In some scenarios, base station 211 may also be referred to as a RAN. Wireless network 210 has an access node 212, a session management node 213, a packet routing node 214, a proxy node 215, an interrogating/serving call session control function (I/S-CSCF) 216, and a TAS 217.

Access node 112, session management node 113, and TAS 117 are within a control plane of wireless network 110, and packet routing node 114 is within a user plane of wireless network 110. Wireless network 210 connects to wireless network 110 through an IMS 220, which has an MRF 222. Base station 211 is in communication with access node 212 and packet routing node 214. Access node 212 is in communication with session management node 213 which is in communication with packet routing node 214, proxy node 215, I/S-CSCF 216, and TAS 217. Packet routing node 214 is in communication with proxy node 215, and packet data network 140 (which is also shown in FIG. 1).

FIG. 3 illustrates further detail for UE 102. When signaling for incoming call 106 arrives at UE 102, rather than called party 101 being provided with only two choices, answer and reject, there is a third choice: “Request call context.” A display 302 on UE 102 initially shows three options, an Answer option 321, a Reject option 322, and a Request call context option 323. In some examples, in addition to display 302 showing options 321-323, UE 102 uses a text to speech function 304 and an audio player 306 to read options 321-323 aloud for called party 101. This may be preferable when called party 101 is using UE 102 in a hands free mode and/or cannot divert their eyes to read display 302. Called party 101 may select one of options 321-323 using a touch input 314 (e.g., keypad or touchscreen) or an audio command picked up by a microphone 310 and converted to an electronic input signal by a speech recognition function 312.

Called party 101 may select any of options 321-323 using a touch input 314. If called party 101 selects Answer option 321, incoming call 106 is connected to UE 102. If called party 101 selects Reject option 322, incoming call 106 is diverted to voicemail, and incoming call 106 is not connected to UE 102. In some examples, Reject option 322 is the default selection when called party 101 does not make a selection prior to a timeout condition (e.g., a countdown timer expiring).

If, however, called party 101 selects Request call context option 323, the messaging between wireless network 110, shown and described in relation to FIGS. 4 and 5, occurs. In some examples, Request call context option 323 is the default selection when called party 101 does not make a selection prior to a timeout condition. (The default behavior, as well as the phrasing of the call context request, may be set by called party 101, in some examples.) At some time shortly after called party 101 selects Request call context option 323—if caller 201 responds, rather than hanging up-display 302 changes to show RTT response 422. Answer option 321 and Reject option 322 are also shown on display 302.

The illustrated version of RTT response 422 is “This is your uncle Bill calling to say Happy Birthday.” If called party 101 had been summarily rejecting all incoming calls from unrecognized phone numbers, believing them to be telemarketing calls, and Uncle Bill's phone number had not been within a contacts list recognized by UE 102 (which would result in Uncle Bill's name being displayed in place of “UNKNOWN”) called party 101 would miss a likely welcome call.

Similarly to the earlier display of options 321-323, in some examples, UE 102 uses text to speech function 304 and audio player 306 to read RTT response 422 (and options 322 and 323) aloud (audibly) for called party 101. Called party 101 may select one of options 322 and 323 using touch input 314 or an audio command picked up by microphone 310 and converted to an electronic input signal by speech recognition function 312. In some examples, if Reject option 322 is selected, incoming call 106 is merely disconnected and caller 201 is not connected to voicemail. In some examples, Reject option 322 is the default selection when called party 101 does not make a selection prior to a timeout condition.

User input 316 is shown as either an instruction 426 to reject incoming call 106 or an instruction 432 to accept incoming call 106. UE 102 transmits either instruction 426 or instruction 432 to wireless network 110, as shown in FIG. 4.

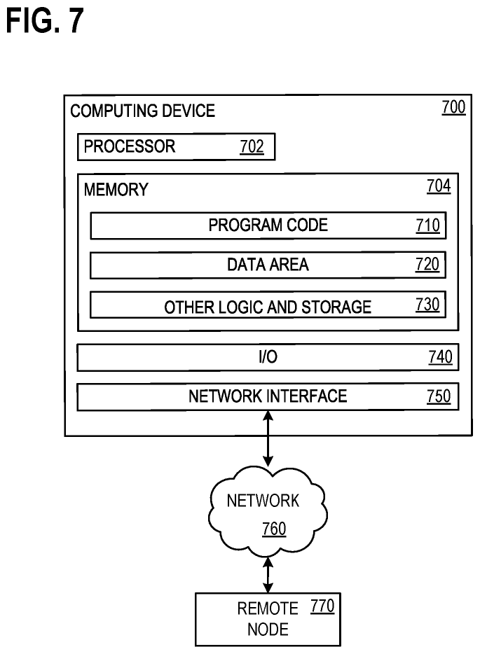

FIG. 4 illustrates a message sequence diagram 400 of massages that may be used in examples of architecture 100, and FIG. 5 illustrates a flowchart 500 of exemplary operations associated with examples of architecture 100. In some examples, at least a portion of flowchart 500 may be performed using one or more computing devices 700 of FIG. 7. FIGS. 4 and 5 are described together.

Flowchart 500 commences with creating default bearer 130 for UE 102, in operation 502. This is part of the registration process of UE 102 with wireless network 110, and is not shown in message sequence diagram 400. In operation 504, remote telephone 202 initiates incoming call 106 to UE 102. This is shown as messages 404a-404e, 406, and 408 in message sequence diagram 400 for the scenario in which remote telephone 202 comprises a second UE operating on wireless network 210. Messages 404a-404e comprise signaling 404 of incoming call 106 and may include a session initiation protocol (SIP) Invite.

In wireless network 210, remote telephone 202 transmits message 404a to proxy node 215 (shown as a P-CSCF), which transmits message 404b to I/S-CSCF 216, which consults with TAS 217 for instructions where to transmit message 404c. This message exchange, between I/S-CSCF 216, and TAS 217 is shown as message 406. I/S-CSCF 216 then transmits message 404c to I/S-CSCF 116 in wireless network 210. I/S-CSCF 116 consults with TAS 117 for instructions where to transmit message 404d. This message exchange, between I/S-CSCF 116, and TAS 117 is shown as message 408. I/S-CSCF 116 then transmits message 404d to proxy node 115 (shown as a P-CSCF).

Proxy node 115 receives incoming call 106 (as message 404d) from remote telephone 202 in operation 506. In operation 508, proxy node 115 forwards incoming call 106 to UE 102, which is shown as message 404e. UE 102 receives incoming call 106 from remote telephone 202 in operation 510, for example over default bearer 130.

In operation 512, without accepting incoming call 106, UE 102 requests that wireless network 110 anchor incoming call 106. This is shown as a message 410 to MRF 122. MRF 122 receives message 410, the request to anchor incoming call 106, from UE 102, in operation 514. In some examples, another node of wireless network 110 wireless network performs the role described herein for MRF 122. MRF 122 has the capability to perform a variety of processing tasks on media streams, such as generating voice (text-to-speech) and converting voice to RTT. In operation 518, MRF 122 selects or converts a request to an audio request 414 (shown as selection/conversion 412 in message sequence diagram 400), and transmits audio request 414 to remote telephone 202. Audio request 414 is a request for call context (i.e., context of incoming call 106).

Remote telephone 202 receives audio request 414 for call context from wireless network 110 in operation 520. In operation 522, caller 201 responds (typically verbally), which is shown as a message 416. Remote telephone 202 transmits audio response 418 to audio request 414 to wireless network 110 (e.g., to MRF 122) in operation 524. MRF 122 receives audio response 418 from remote telephone 202 in operation 526, and converts audio response 418 to RTT response 422 in operation 528. This is shown as conversion 420 in message sequence diagram 400. MRF 122 transmits RTT response 422 to UE 102 (e.g., on default bearer 130) in operation 530, and caller 201 hears ringing, shown as a message 424 from UE 102 to remote telephone 202.

UE 102 receives RTT response 422 in operation 532, and displays RTT response 422 or reads RTT response 422 aloud as a text-to-speech generated audio response in operation 534. Called party 101 enters either instruction 426 to reject incoming call 106 or instruction 432 to accept incoming call 106 into UE 102, either as a touch entry or an audio command (or waiting for a timeout, in the case of instruction 426 to reject incoming call 106) as user input 316. UE receives user input 316 in operation 536.

In decision operation, UE 102 determines whether to accept or reject incoming call, based on user input 316. If the decision is to reject (instruction 426), UE 102 transmits an indication 428 of rejecting incoming call 106 to wireless network 110 in operation 540. In operation 542, based on at least receiving indication 428 of rejecting incoming call 106 from UE 102, wireless network 110, terminates incoming call 106 without connecting incoming call 106 to voicemail. The call termination is shown as a message 430 to remote telephone 202.

If the decision is to accept (instruction 432), UE 102 transmits an indication 434 of accepting incoming call 106 to wireless network 110 in operation 544. In operation 546, based on at least receiving indication 434 of accepting incoming call 106, wireless network 110 creates dedicated bearer 132 for UE 102. Wireless network 110 then connects incoming call 106 to UE 102, using dedicated bearer 132, in operation 548.

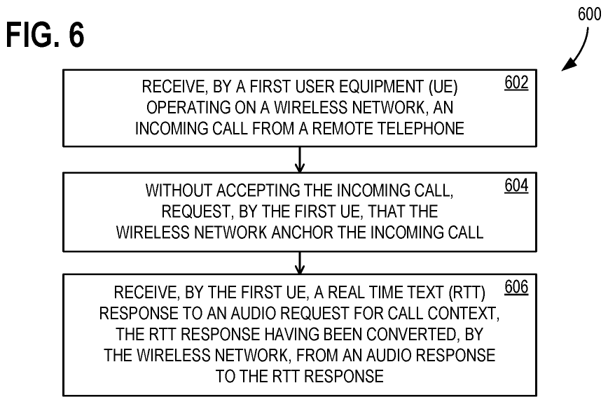

FIG. 6 illustrates a flowchart 600 of exemplary operations associated with examples of architecture 100. In some examples, at least a portion of flowchart 600 may be performed using one or more computing devices 700 of FIG. 7. Flowchart 600 commences with operation 602, which includes receiving, by a first UE operating on a wireless network, an incoming call from a remote telephone.

Operation 604 includes, without accepting the incoming call, requesting, by the first UE, that the wireless network anchor the incoming call. Operation 606 includes receiving, by the first UE, an RTT response to an audio request for call context, the RTT response having been converted, by the wireless network, from an audio response to the RTT response.

FIG. 7 illustrates a block diagram of computing device 700 that may be used as any component described herein that may require computational or storage capacity. Computing device 700 has at least a processor 702 and a memory 704 that holds program code 710, data area 720, and other logic and storage 730. Memory 704 is any device allowing information, such as computer executable instructions and/or other data, to be stored and retrieved. For example, memory 704 may include one or more random access memory (RAM) modules, flash memory modules, hard disks, solid-state disks, persistent memory devices, and/or optical disks. Program code 710 comprises computer executable instructions and computer executable components including instructions used to perform operations described herein. Data area 720 holds data used to perform operations described herein. Memory 704 also includes other logic and storage 730 that performs or facilitates other functions disclosed herein or otherwise required of computing device 700. An input/output (I/O) component 740 facilitates receiving input from users and other devices and generating displays for users and outputs for other devices. A network interface 750 permits communication over external network 760 with a remote node 770, which may represent another implementation of computing device 700. For example, a remote node 770 may represent another of the above-noted nodes within architecture 100.

### ADDITIONAL EXAMPLES

An example system comprises: a processor; and a computer-readable medium storing instructions that are operative upon execution by the processor to: receive, by a first UE operating on a wireless network, an incoming call from a remote telephone; without accepting the incoming call, request, by the first UE, that the wireless network anchor the incoming call; and receive, by the first UE, an RTT response to an audio request for call context, the RTT response having been converted, by the wireless network, from an audio response to the RTT response.

An example method of wireless communication comprises: receiving, by a first UE operating on a wireless network, an incoming call from a remote telephone; without accepting the incoming call, requesting, by the first UE, that the wireless network anchor the incoming call; and receiving, by the first UE, an RTT response to an audio request for call context, the RTT response having been converted, by the wireless network, from an audio response to the RTT response.

One or more example computer storage devices has computer-executable instructions stored thereon, which, upon execution by a computer, cause the computer to perform operations comprising: receiving, by a first UE operating on a wireless network, an incoming call from a remote telephone; without accepting the incoming call, requesting, by the first UE, that the wireless network anchor the incoming call; and receiving, by the first UE, an RTT response to an audio request for call context, the RTT response having been converted, by the wireless network, from an audio response to the RTT response.

Alternatively, or in addition to the other examples described herein, examples include any combination of the following:
displaying, on the first UE, the RTT response or reading, by the first UE, the audio response aloud;
receiving, by the first UE, an instruction to accept the incoming call or an instruction to reject the incoming call;
based on at least receiving the instruction to accept the incoming call, transmitting, to the wireless network, an indication of accepting the incoming call;
based on at least receiving the instruction to reject the incoming call, transmitting, to the wireless network, an indication of rejecting the incoming call;
based on at least receiving, by the wireless network, from the first UE, the indication of rejecting the incoming call, terminating the incoming call without connecting the incoming call to voicemail;
based on at least receiving, by the wireless network, from the first UE, the indication of accepting the incoming call, creating a dedicated bearer for the first UE;
based on at least receiving, by the wireless network, from the first UE, the indication of accepting the incoming call, connecting the incoming call to the first UE, using the dedicated bearer;
receiving, by a first network node of the wireless network, from the remote telephone, the incoming call;
forwarding, by the first network node, to the first UE, the incoming call;
receiving, by a second network node of the wireless network, from the first UE, the request to anchor the incoming call;
anchoring the incoming call at the second network node;
transmitting, to the remote telephone, an audio request for call context;
receiving, by the second network node, from the remote telephone, an audio response to the audio request for call context;
converting, by the second network node, the audio response to an RTT response;
transmitting, to the first UE, the RTT response;
the second network node comprises an MRF;
transmitting the RTT response to the first UE comprises transmitting the RTT response on a default bearer;
initiating, by the remote telephone, the incoming call to the first UE;
receiving, by the remote telephone, from the wireless network, an audio request for call context;
transmitting, by the remote telephone, to the wireless network, an audio response to the audio request for call context;
creating the default bearer for the first UE;
receiving, by the first UE, the incoming call from the remote telephone comprises receiving signaling for the incoming call over the default bearer;
the signaling for the incoming call comprises a SIP invite;
the incoming call comprises a voice call;
the remote telephone comprises a second UE operating on the wireless network;
the remote telephone comprises a second UE operating on a second wireless network;
the second UE has RTT capability;
the second UE does not have RTT capability;
the first network node comprises a P-CSCF;
the wireless network comprises a cellular network;
the wireless network comprises a 5G cellular network;
receiving, by the first UE, the RTT response comprises receiving the RTT response over the default bearer;
the instruction to accept the incoming call comprises a first user entry on the first UE;
the first user entry comprises a touch entry or audio command;
the instruction to reject the incoming call comprises a second user entry on the first UE or a timeout condition; and
the second user entry comprises a touch entry or audio command.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of wireless communication, the method comprising:
receiving, by a first user equipment (UE) operating on a wireless network, an incoming call from a remote telephone;
without accepting the incoming call, requesting, by the first UE, that the wireless network anchor the incoming call; and
receiving, by the first UE, a real time text (RTT) response to an audio request for call context, the RTT response having been converted, by the wireless network, from an audio response to the RTT response.

2. The method of claim 1, further comprising:
displaying, on the first UE, the RTT response or reading, by the first UE, the audio response aloud;
receiving, by the first UE, an instruction to accept the incoming call or an instruction to reject the incoming call;
based on at least receiving the instruction to accept the incoming call, transmitting, to the wireless network, an indication of accepting the incoming call; and
based on at least receiving the instruction to reject the incoming call, transmitting, to the wireless network, an indication of rejecting the incoming call.

3. The method of claim 2, further comprising:
based on at least receiving, by the wireless network, from the first UE, the indication of rejecting the incoming call, terminating the incoming call without connecting the incoming call to voicemail.

4. The method of claim 2, further comprising:
based on at least receiving, by the wireless network, from the first UE, the indication of accepting the incoming call:
creating a dedicated bearer for the first UE; and
connecting the incoming call to the first UE, using the dedicated bearer.

5. The method of claim 1, further comprising:
receiving, by a first network node of the wireless network, from the remote telephone, the incoming call;
forwarding, by the first network node, to the first UE, the incoming call;
receiving, by a second network node of the wireless network, from the first UE, the request to anchor the incoming call;
anchoring the incoming call at the second network node;
transmitting, to the remote telephone, an audio request for call context;
receiving, by the second network node, from the remote telephone, an audio response to the audio request for call context;
converting, by the second network node, the audio response to an RTT response; and
transmitting, to the first UE, the RTT response.

6. The method of claim 5, wherein the second network node comprises a media resource function (MRF), and wherein transmitting the RTT response to the first UE comprises transmitting the RTT response on a default bearer.

7. The method of claim 1, further comprising:
initiating, by the remote telephone, the incoming call to the first UE;
receiving, by the remote telephone, from the wireless network, an audio request for call context; and
transmitting, by the remote telephone, to the wireless network, an audio response to the audio request for call context.

8. A system comprising:
a processor; and
a computer-readable medium storing instructions that are operative upon execution by the processor to:
receive, by a first user equipment (UE) operating on a wireless network, an incoming call from a remote telephone;
without accepting the incoming call, request, by the first UE, that the wireless network anchor the incoming call; and
receive, by the first UE, a real time text (RTT) response to an audio request for call context, the RTT response having been converted, by the wireless network, from an audio response to the RTT response.

9. The system of claim 8, wherein the instructions are further operative to:
display, on the first UE, the RTT response or reading, by the first UE, the audio response aloud;
receive, by the first UE, an instruction to accept the incoming call or an instruction to reject the incoming call;
based on at least receiving the instruction to accept the incoming call, transmit, to the wireless network, an indication of accepting the incoming call; and
based on at least receiving the instruction to reject the incoming call, transmit, to the wireless network, an indication of rejecting the incoming call.

10. The system of claim 9, wherein the instructions are further operative to:
based on at least receiving, by the wireless network, from the first UE, the indication of rejecting the incoming call, terminate the incoming call without connecting the incoming call to voicemail.

11. The system of claim 9, wherein the instructions are further operative to:
based on at least receiving, by the wireless network, from the first UE, the indication of accepting the incoming call:
create a dedicated bearer for the first UE; and
connect the incoming call to the first UE, using the dedicated bearer.

12. The system of claim 8, wherein the instructions are further operative to:
receive, by a first network node of the wireless network, from the remote telephone, the incoming call;
forward, by the first network node, to the first UE, the incoming call;
receive, by a second network node of the wireless network, from the first UE, the request to anchor the incoming call;
anchor the incoming call at the second network node;
transmit, to the remote telephone, an audio request for call context;
receive, by the second network node, from the remote telephone, an audio response to the audio request for call context;
convert, by the second network node, the audio response to an RTT response; and
transmit, to the first UE, the RTT response.

13. The system of claim 12, wherein the second network node comprises a media resource function (MRF), and wherein transmitting the RTT response to the first UE comprises transmitting the RTT response on a default bearer.

14. The system of claim 8, wherein the instructions are further operative to:
initiate, by the remote telephone, the incoming call to the first UE;
receive, by the remote telephone, from the wireless network, an audio request for call context; and
transmit, by the remote telephone, to the wireless network, an audio response to the audio request for call context.

15. One or more computer storage devices having computer-executable instructions stored thereon, which, upon execution by a computer, cause the computer to perform operations comprising:
receiving, by a first user equipment (UE) operating on a wireless network, an incoming call from a remote telephone;
without accepting the incoming call, requesting, by the first UE, that the wireless network anchor the incoming call; and
receiving, by the first UE, a real time text (RTT) response to an audio request for call context, the RTT response having been converted, by the wireless network, from an audio response to the RTT response.

16. The one or more computer storage devices of claim 15, wherein the operations further comprise:
displaying, on the first UE, the RTT response or reading, by the first UE, the audio response aloud;
receiving, by the first UE, an instruction to accept the incoming call or an instruction to reject the incoming call;
based on at least receiving the instruction to accept the incoming call, transmitting, to the wireless network, an indication of accepting the incoming call; and
based on at least receiving the instruction to reject the incoming call, transmitting, to the wireless network, an indication of rejecting the incoming call.

17. The one or more computer storage devices of claim 16, wherein the operations further comprise:
based on at least receiving, by the wireless network, from the first UE, the indication of rejecting the incoming call, terminating the incoming call without connecting the incoming call to voicemail.

18. The one or more computer storage devices of claim 16, wherein the operations further comprise:
based on at least receiving, by the wireless network, from the first UE, the indication of accepting the incoming call:
creating a dedicated bearer for the first UE; and
connecting the incoming call to the first UE, using the dedicated bearer.

19. The one or more computer storage devices of claim 15, wherein the operations further comprise:
receiving, by a first network node of the wireless network, from the remote telephone, the incoming call;
forwarding, by the first network node, to the first UE, the incoming call;
receiving, by a second network node of the wireless network, from the first UE, the request to anchor the incoming call;
anchoring the incoming call at the second network node;
transmitting, to the remote telephone, an audio request for call context;
receiving, by the second network node, from the remote telephone, an audio response to the audio request for call context;
converting, by the second network node, the audio response to an RTT response; and
transmitting, to the first UE, the RTT response.

20. The one or more computer storage devices of claim 19, wherein the second network node comprises a media resource function (MRF), and wherein transmitting the RTT response to the first UE comprises transmitting the RTT response on a default bearer.
